(19) United States
(12) Patent Application Publication
(10) Pub. No.: US 2014/0287620 A1
(43) Pub. Date: Sep. 25, 2014

(54) USB CONNECTOR STRUCTURE

(71) Applicant: ZK-TEK Technologies Co., Ltd., New Taipei City (TW)

(72) Inventor: Yi Chia CHAN, New Taipei City (TW)

(21) Appl. No.: 13/929,416

(22) Filed: Jun. 27, 2013

(30) Foreign Application Priority Data
Mar. 20, 2013 (TW) TW102205163

(51) Int. Cl. H01R 12/51

(52) U.S. Cl. CPC H01R 12/51
USPC 439/571

(57) ABSTRACT

The present invention relates to a USB connector structure, and more specifically, refers to a connector structure which is applied in memory device of USB drive.

### BACKGROUND OF THE INVENTION

1. Field of the Invention

The present invention relates to a USB connector structure, comprising an isolated block, which is configured with a plural of conducting pins, and a front shell, which is inserted by the isolated block and is both laterally extended as clipping arms to enable a stable assembled structure and enhance a firm supporting ability with the base, and to reduce transmission failure between pins and the base after many times plug-in and pull-out.

2. Description of Prior Art

The USB (Universal Serial Bus) connectors had been widely adopted as a standard port to function as a transmission interface between the computer and external peripherals. Especially, USB connectors are popularly used in memory storage device and equipped with function of ‘hot plugging’ or ‘plug and play’. Following the trend to be lighter, thinner and smaller, there are several USB connectors' specification had been released. They are standard A type, B type, Mini USB and Micro USB. So far, most of the USB connectors adopted in portable drive are standard A type. However, Micro USB was used in mobile phone and mini laptop for the recent years. There must be some bridge to connect between A type and Micro USB for expanding the memory size.

Prior USB connectors usually adopted a metal front shell to wrap a plastic isolated block which is laid with a plural of conducting pins. The whole USB connector is supported by the conducting pins soldered with the base which is located at the back of USB drive. And, it resulted into a transmission failure between pins and the base after many times plug-in and pull-out due to a poor contact status.

In view of the above discussed problems, the present invention aims to improve such a transmission failure and provide a convenient method to enhance the structure assembly for USB connectors.

### SUMMARY OF THE INVENTION

The primary object of the present invention is to provide a USB connector structure, wherein the clipping arms configured in the USB are applied to provide a clip or firm attachment with the base and reduce transmission failure after multi plug-in and plug-out between those conducting pins and the base at the rear position.

To achieve the purpose described above, the present invention, a USB connector structure, takes certain technical steps and comprises:

an isolated block, which is configured with a plural of conducting pins, and

a front shell, which is inserted by the isolated block and is both laterally extended as clipping arms.

The clipping arms are configured at both sides of the front shell. And, the clipping arms are further configured with upper fixing parts and lower fixing parts, wherein there is a clipping space formed to hold and accommodate the base between said fixing parts, to provide a stable supporting ability with the base, and to reduce transmission failure between pins and the base after repeated plug-in and pull-out.

The clipping arms are, alternatively, further including upper fixing parts and side stoppers, which have a firm attachment at the top surface and the front side of the base respectively.

The isolated block and the front shell are configured with coupling structure to combine with each other. And, the present invention can be further configured with a casing at the rear position of said isolated block and the front shell. The coupling structure, configured both at the isolated block and the front shell, can be applied at either top or lower side correspondingly. Meanwhile, the coupling structure of the casing can be a notch with or without a penetrable opening, and that of the isolated block is a protruding rib. Or, the coupling structure of the casing is a protruding rib and that of the isolated block is a notch.

By above-mentioned description, the present invention is applicable to provide a USB connector structure with a more efficient manufacturing process and a more reliable hardware structure. Above all, the present invention is assembled free from soldering and provides a convenient and efficient method to shorten prior USB connector manufacturing process.

The function and structure of practical embodiments can be further understood via the drawings listed below.

### BRIEF DESCRIPTION OF THE DRAWINGS AND ELEMENTS

The present invention can be fully understood from the following detailed description and preferred embodiment with reference to the accompanying drawings, in which:

FIG. 1 illustrates a three-dimensional decomposition view of the first embodiment related to the present invention.

FIG. 2 illustrates a schematic elevation view of the first embodiment.

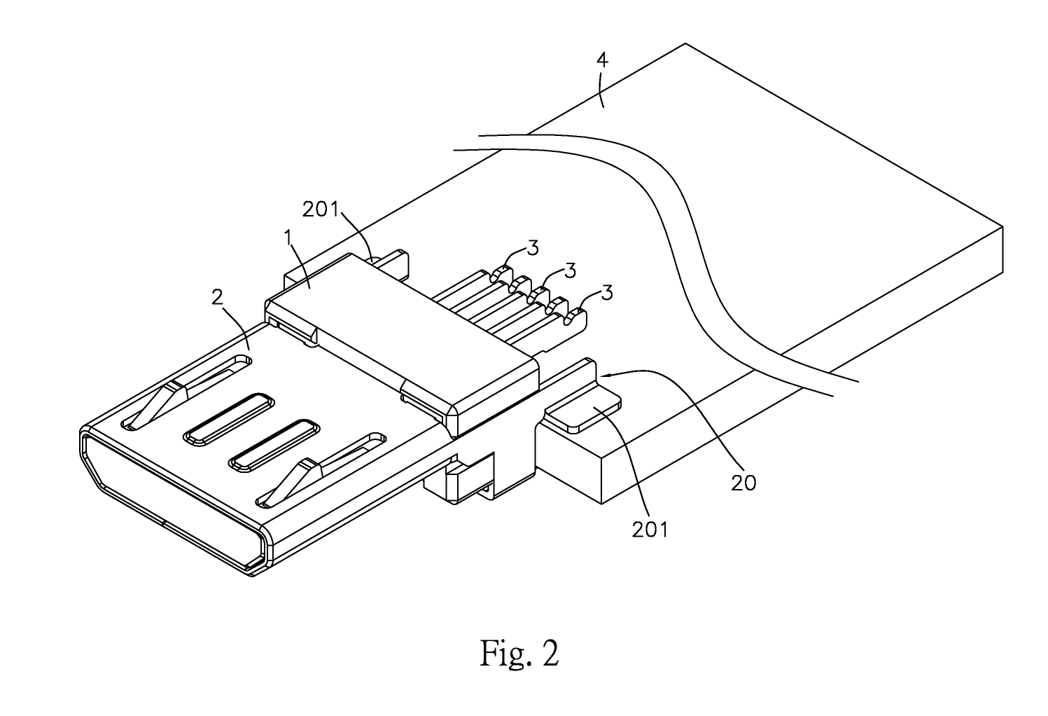

FIG. 3 illustrates an A-A schematic cross-section view of the present invention.

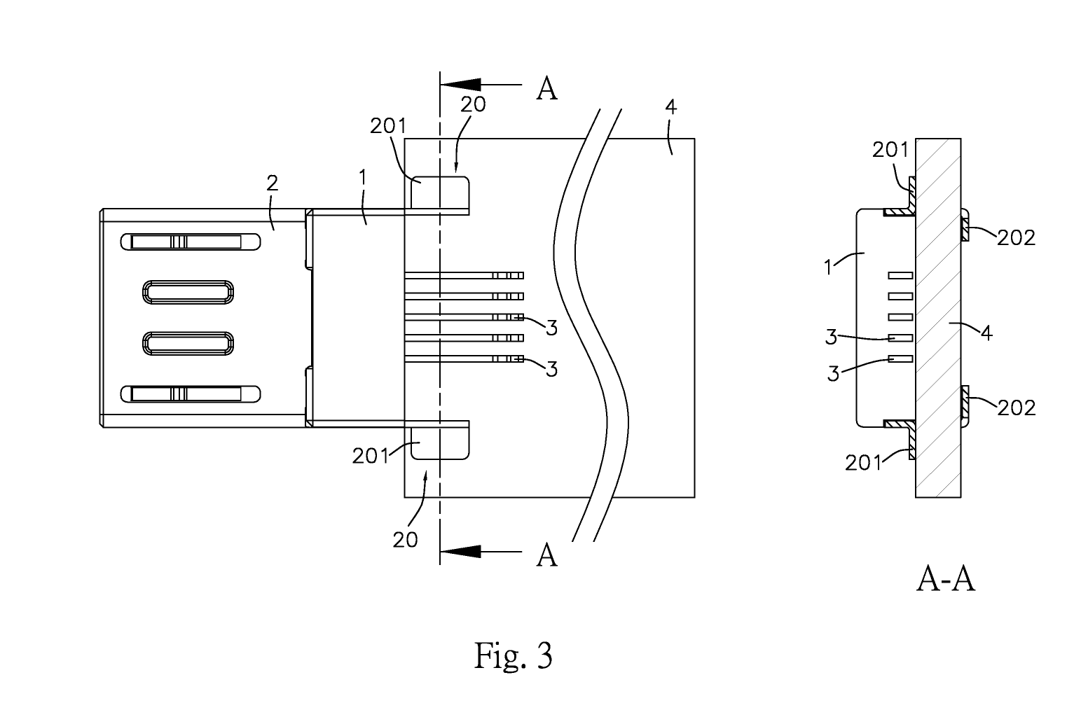

FIG. 4 illustrates a three-dimensional decomposition view of the second embodiment related to the present invention.

FIG. 5 illustrates a schematic elevation view of the second embodiment.

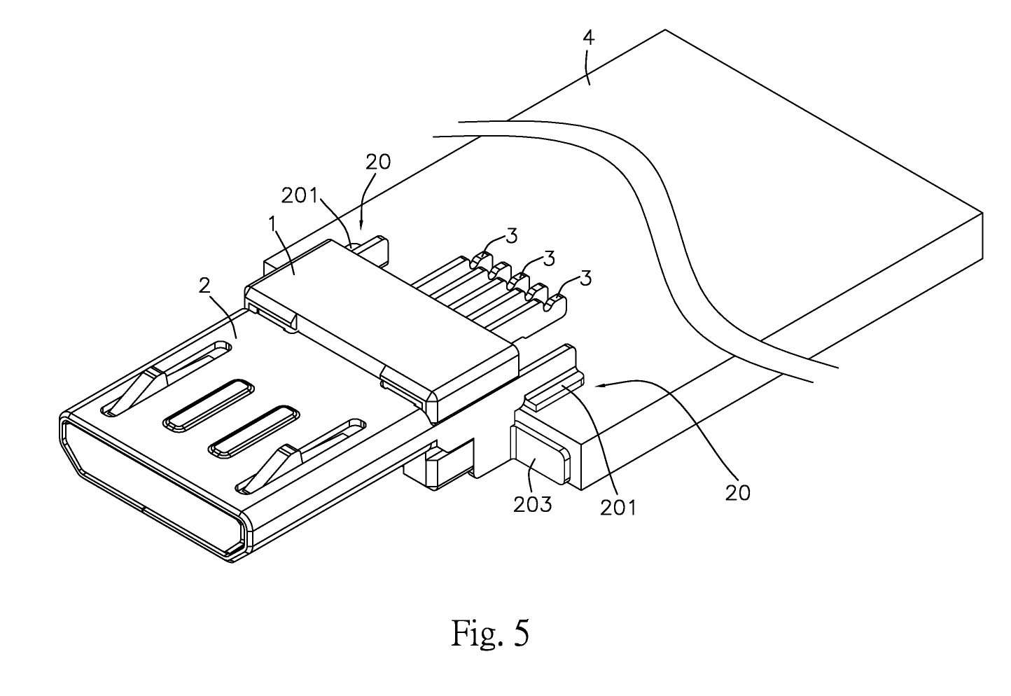

FIG. 6 illustrates a schematic elevation view without casing related to the third embodiment.

FIG. 7 illustrates a schematic elevation view of the third embodiment.

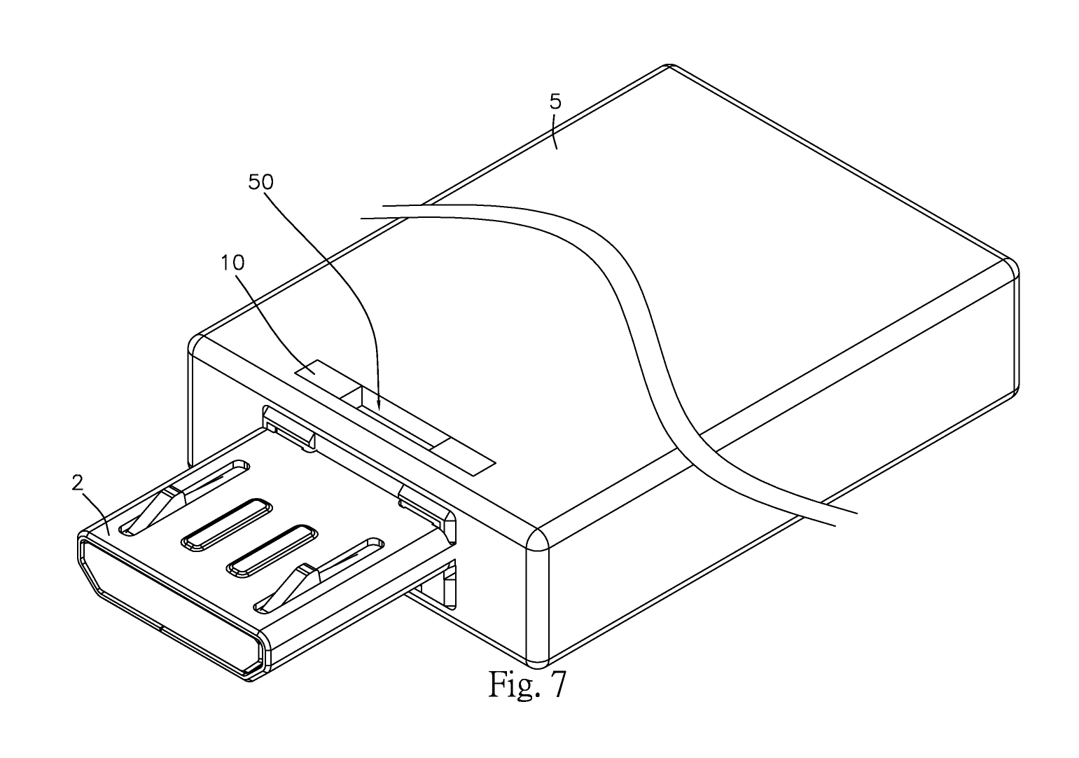

FIG. 8 illustrates a schematic cross-section view related to the third embodiment.

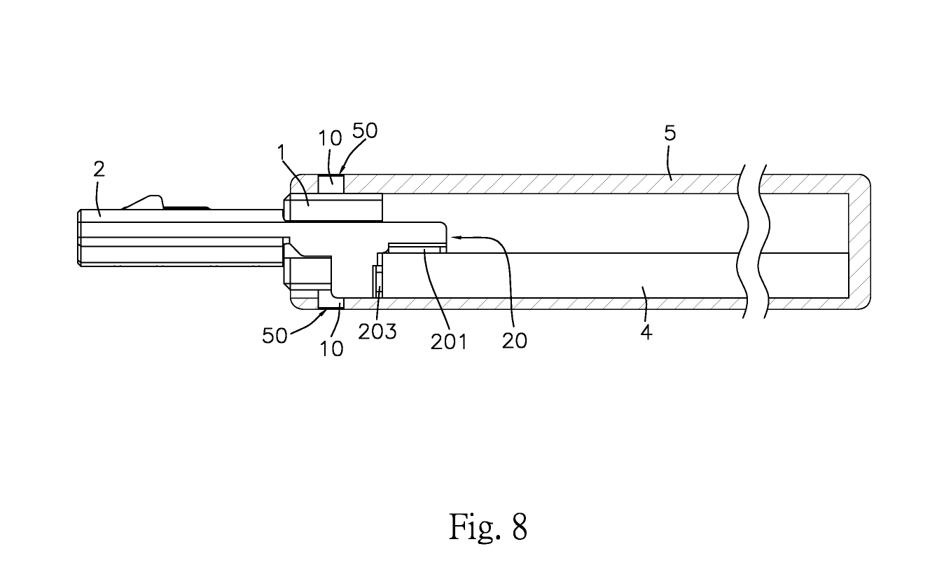

FIG. 9 illustrates a schematic elevation view of the fourth embodiment.

FIG. 10 illustrates a schematic cross-section view related to the fourth embodiment.

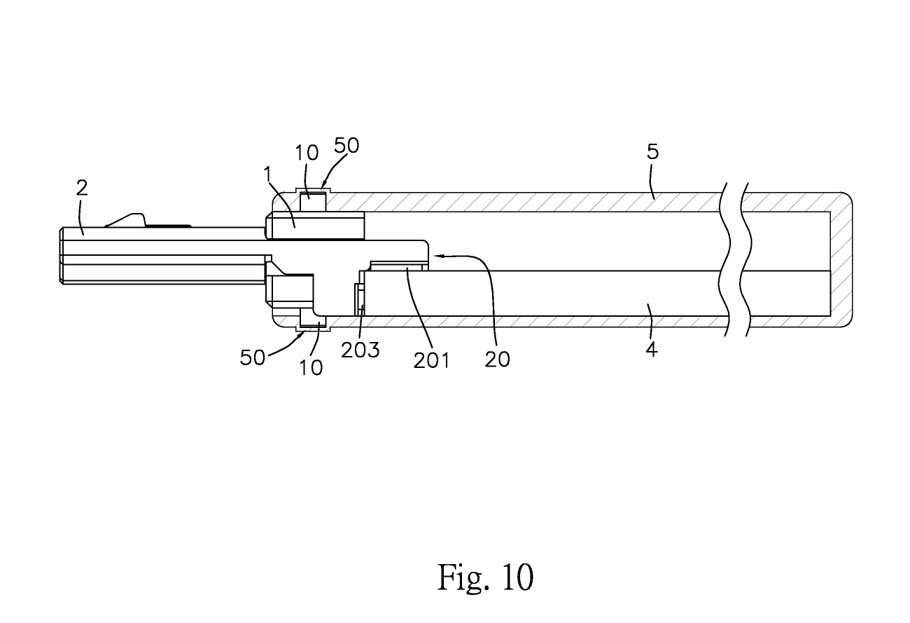

FIG. 11 illustrates a schematic elevation view of the fifth embodiment.

FIG. 12 illustrates a schematic cross-section view related to the fifth embodiment.

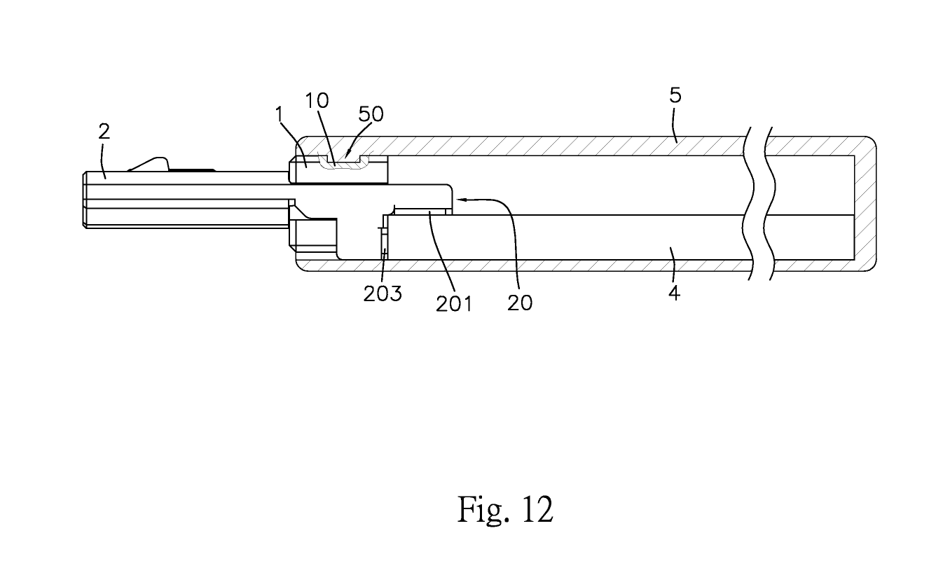

The elements related to the present invention are listed as follows:

| | | | |
|---|---|---|---|
| 1, | isolated block | 2, | front shell |
| 3, | pins | 4, | base |
| 5, | casing | 10, | coupling structure |
| 20, | clipping arms | 50, | coupling structure |
| 201, | upper fixing part | 202, | lower fixing part |
| 203, | side stopper | | |

### DETAILED DESCRIPTION OF THE PREFERRED EMBODIMENTS

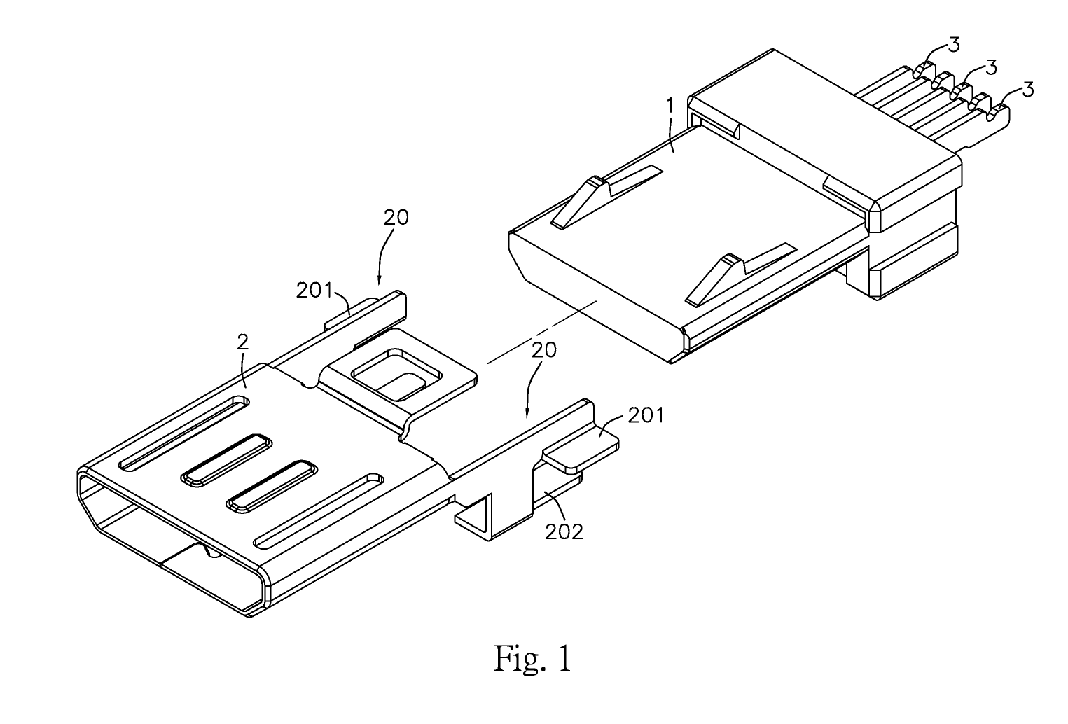

Referring to FIGS. 1˜3, they illustrate a three-dimensional decomposition view, a schematic elevation view and an A-A schematic cross-section view of the first embodiment. The present invention comprises an isolated block 1 and a front shell 2, wherein the isolated block 1 is configured with a plural of conducting pins 3 which are laid and fixed over the base 4 and enables electrical connection between USB connector and the base 4. The base 4 is, but not limited as, a COB (Chip-On-Board) structure. The front shell 2 can be configured with metal material to be inserted by the isolated block 1. The isolated block 1 is then wrapped by the front shell 2 which is both laterally extended as clipping arms 20. And, the clipping arms 20 are further including upper fixing parts 201 and lower fixing parts 202, wherein there is a clipping space formed to hold and accommodate the base 4 between said fixing parts 201, 202, to provide a stable supporting ability with the base 4, and to balance the stress focused on the pins 3 and to reduce transmission failure between pins 3 and the base 4 after repeated plug-in and pull-out.

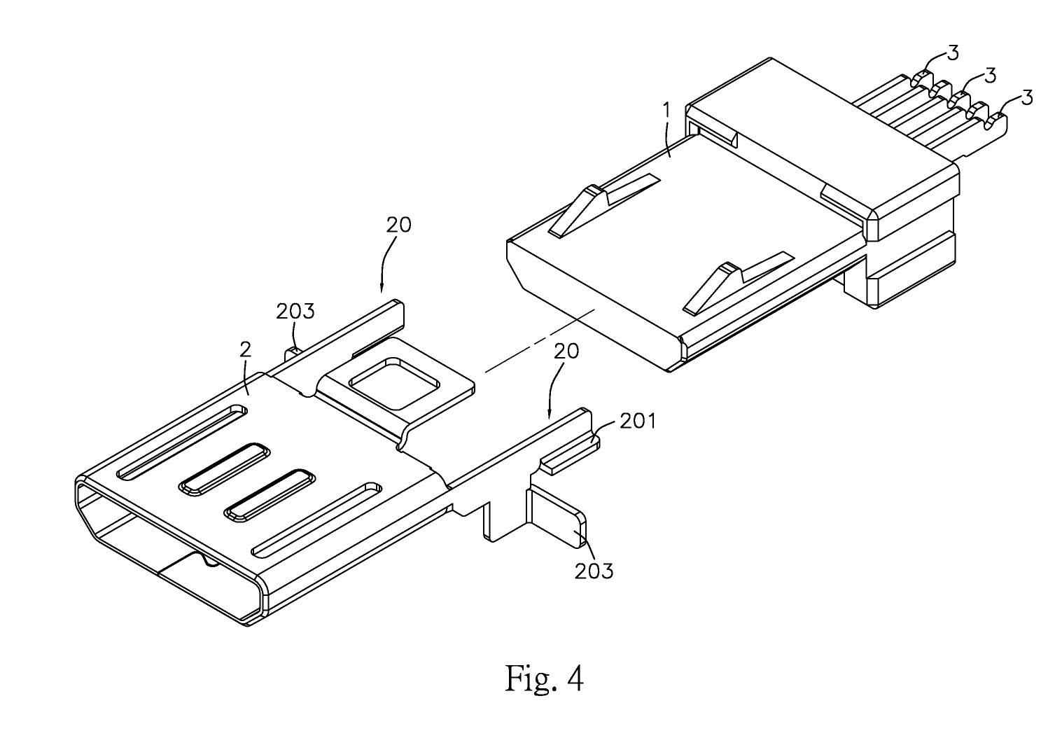

Please refer to FIGS. 4˜5, they illustrate a three-dimensional decomposition view and a schematic elevation view of the second embodiment, which is different from the first embodiment and the difference lies in the clipping arms 20 is configured with upper fixing parts 201, which hold and press the front top surface of the base 4, and side stoppers 203, which hold a firm attachment against front side of the base 4 respectively.

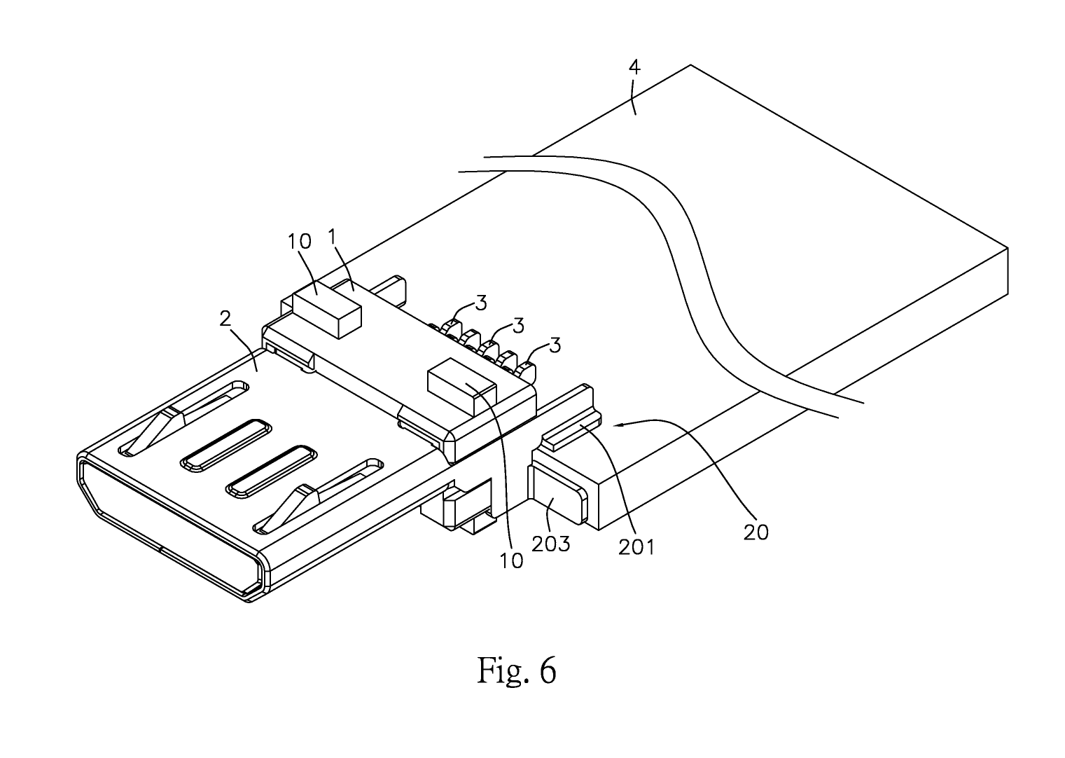

Please refer to FIGS. 6˜8, which shows the third embodiment related to the present invention, which is further configured with a casing 5 at the rear position of said isolated block 1 and the front shell 2 to protect inner base 4. Besides, the casing 5 and the isolated block are correspondingly configured with coupling structure 10, 50 which can be a notch with a penetrable opening in the casing 5, and is a protruding rib in the isolated block 1 to fit with each other. Both coupling structure 10, 50 can be applied either at the top side or lower side of joint assembly of casing 5 and isolated block 1.

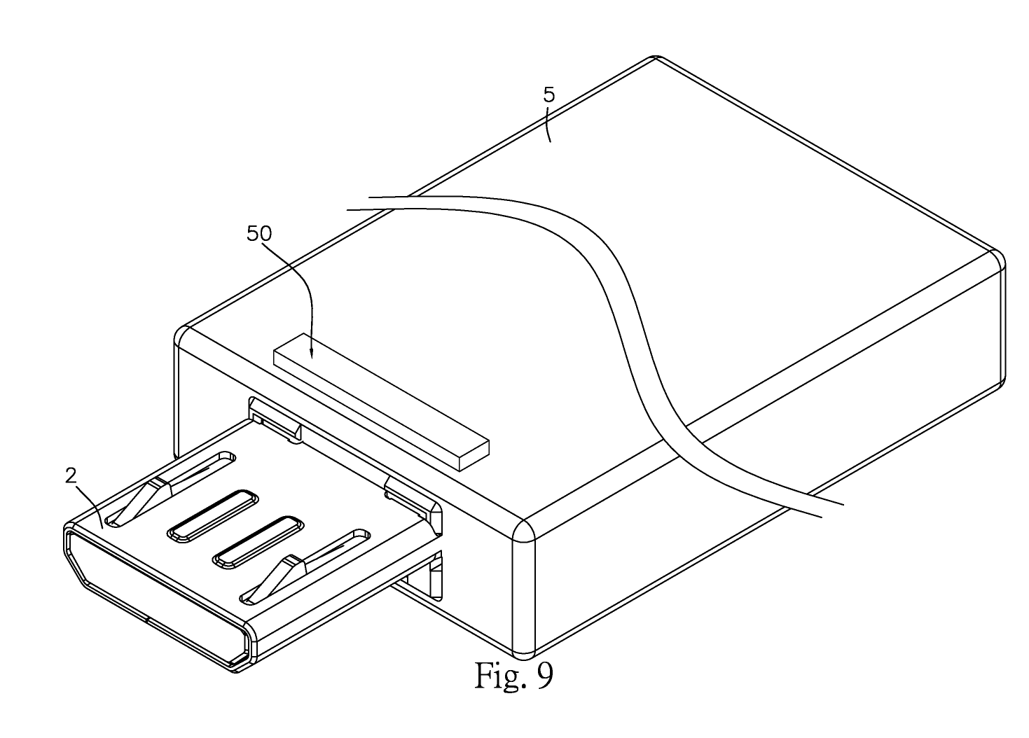

Please refer to FIGS. 9˜10, which shows the fourth embodiment and the difference lies in that the coupling structure 50 located at either top or lower side of the casing 5 is a long shape notch without penetrable opening.

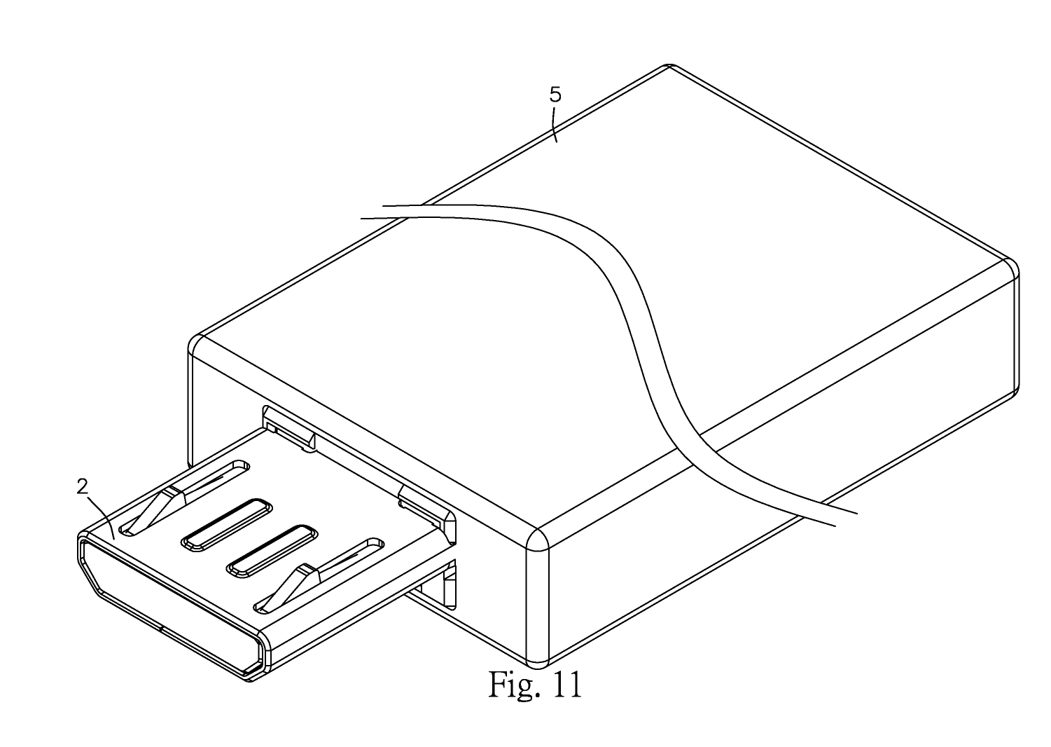

Finally, please refer to FIGS. 11˜12, which shows the fifth embodiment and the coupling structure 50 of the casing 5 is an inner protruding rib. And, the coupling structure 10 of the isolated block 1 is a long notch to fit and be configured with the said protruding coupling structure 50. Therefore, the present invention provides a firm and stable joint assembly of USB connector and casing 5.

According to the description above, it is to be understood that the embodiments described herein are merely some illustrations related to the objects of the invention and that a wide variety of modifications thereto may be adopted without departing from the purpose and the scope of the present invention as set forth in the following claims.

What is claimed is:

1. A USB connector structure, comprises
an isolated block, which is configured and laid with a plural of conducting pins, and
a front shell, which is inserted by the isolated block and is both laterally extended as clipping arms.

2. A USB connector structure according to claim 1, wherein the clipping arms are further configured with upper fixing parts and lower fixing parts.

3. A USB connector structure according to claim 2, wherein there is a clipping space formed between upper fixing parts and lower fixing parts to accommodate the base.

4. A USB connector structure according to claim 1, wherein the clipping arms are further configured with upper fixing parts and side stoppers.

5. A USB connector structure according to claim 4, wherein the upper fixing parts have an attachment at the top surface and the side stoppers stop the front side of the base respectively.

6. A USB connector structure according to claim 1, wherein the isolated block and the front shell are configured with a casing at the rear position , and are configured with coupling structure to join with each other respectively.

7. A USB connector structure according to claim 6, the coupling structure of the casing is a notch with or without a penetrable opening, and the coupling structure of the isolated block is a protruding rib.

8. A USB connector structure according to claim 7, wherein the coupling structure configured both at the isolated block and the front shell are applied at either top or lower side correspondingly.

9. A USB connector structure according to claim 6, wherein the coupling structure of the casing is a protruding rib and the coupling structure of the isolated block is a notch.
